(19) United States
(12) Patent Application Publication
(10) Pub. No.: US 2003/0060741 A1
(43) Pub. Date: Mar. 27, 2003

(54) Massage chair using solenoid

(75) Inventor: Jeung Hoon Park, Seoul (KR)

Correspondence Address: Ladas & Parry, 26 West 61st Street, New York, NY, 10023, US

(73) Assignee: BEAUNIX CO., LTD.

(21) Appl. No.: 10/222,512

(22) Filed: Aug. 16, 2002

(30) Foreign Application Priority Data
Aug. 27, 2001 (KR) P2001-51903

(51) Int. Cl. A61H 1/00; A61H 1/02

(52) U.S. Cl. 601/20

(57) ABSTRACT

In a massage chair which includes a foot bath tub capable of spraying water to a user's feet at a high pressure, a seat unit on which a user sits, a rotation device capable of adjusting a tilting angle in a front and rear direction of a backrest, and a moving device capable of forwardly and backwardly moving the seat unit, a massage chair using a solenoid includes a fixing belt which is embedded in a receiving groove formed in the interior of the backrest in a longitudinal direction, a plurality of solenoids which are installed in the fixing belt in a longitudinal direction of the backrest by at least one line and pressurize a user's back who sits on the seat unit as a rod reciprocates by a magnetic force occurring when a power is supplied to a coil, and a fixing unit for fixing the solenoid to the fixing belt.

### BACKGROUND OF THE INVENTION

1. Field of the Invention

The present invention relates to a massage chair using a solenoid, and in particular to a massage chair using a solenoid in which a seat is movable forwardly and backwardly, a backrest is tiltable at a certain angle, and a user's back supported by a backrest is massaged based on an operation of a solenoid in a massage chair which is capable of massaging a user's back and a user's feet by forming a whirl pool in such a manner that water is sprayed to feet.

2. Description of the Background Art

A massage chair is designed for massaging a user's back, neck, etc. without other's assistances for thereby relieving a user's fatigue. Recently, a massage chair is capable of relieving a user's back and neck as well as a user's feet by providing a foot massage function which is implemented by spraying water to feet.

However, a conventional massage chair capable of implementing a foot massage includes a seat formed of a backrest including a massage device and a seat unit which supports a user's hip. In the above conventional massage chair, it is impossible to adjust an inclination angle of a backrest, and since a seat and a foot bathtub are fixed, it is impossible to adjust a distance between the seat and the foot bathtub, so that a conventional massage chair is not properly fitted to each user's body style and size.

### SUMMARY OF THE INVENTION

Accordingly, it is an object of the present invention to provide a massage chair using a solenoid which overcomes the problems encountered in the conventional art.

It is another object of the present invention to provide a massage chair using a solenoid which is capable of massaging a user's back and neck and a sole and top of a user's foot using a whirlpool formed in a foot bath tub.

It is another object of the present invention to provide a massage chair using a solenoid in which an installation angle of a backrest is adjustable, and a seat unit is movable forwardly and backwardly, so that a massage chair is capable of being fitted to each user's body style and size with respect to a user's sitting posture for thereby effectively performing a massage of a user back and feet.

It is further another object of the present invention to provide a massage chair using a solenoid which implements a simple construction using a solenoid as a mechanism element capable of massaging a user's back and implements a better durability.

To achieve the above objects, there is provided a massage chair using a solenoid which includes a fixing belt which is embedded in a receiving groove formed in the interior of the backrest in a longitudinal direction, a plurality of solenoids which are installed in the fixing belt in a longitudinal direction of the backrest by at least one line and pressurize a user's back who sits on the seat unit as a rod reciprocates by a magnetic force occurring when a power is supplied to a coil, and a fixing unit for fixing the solenoid to the fixing belt wherein the massage chair includes a foot bath tub capable of spraying water to a user's feet at a high pressure, a seat unit on which a user sits, a rotation device capable of adjusting a tilting angle in a front and rear direction of a backrest, and a moving device capable of forwardly and backwardly moving the seat unit.

In addition, a cushion member is fixed to an end portion of the rod of the solenoid.

A slit is formed in an upper surface of the cushion member is a radius direction.

The solenoid is fixed to left and right sides of the fixing belt, respectively, and is arranged in a longitudinal direction of the backrest.

The fixing unit includes a support plate which is fixed to a lower surface of the fixing belt and is extended in a direction of both sides of the fixing belt, a bracket which covers both side surfaces and lower surface of the solenoid and includes an upper end which is outwardly bent and is mounted on the support plate, and a fixing plate which is fixed in an upper end of the bracket, wherein an end portion of the fixing plate is fixed by a bolt which passes through the bracket and the support plate, and the other end of the same is fixed to the solenoid by another bolt.

The fixing belt is fixed tensely in a ring shape and receives a fixing plate fixed to an upper and lower surface of the support frame which is formed along an inner outer circumferential surface of the backrest.

To achieve the above objects, there is provided a massage chair using a solenoid which includes a plurality of casings which are embedded in an inner layer of the backrest in an upward and downward direction and includes an opened upper portion, a plurality of solenoids which are installed in a housing engaged to a fixing member of the casing, with a rod engaged to a through hole formed in a center portion reciprocating by a magnetic force which occurs when a power is supplied-to a coil, and are connected in parallel, a cushion member which is fixed to an end portion of a protrusion shaft extended from the rod, and a first elastic member which is installed between an upper surface of the solenoid and the cushion member and elastically recovers during a vibration of the rod wherein the massage chair includes a foot bath tub capable of spraying water to a user's feet at a high pressure, a seat unit on which a user sits, a rotation device capable of adjusting a tilting angle in a front and rear direction of a backrest, and a moving device capable of forwardly and backwardly moving the seat unit.

In addition, a second elastic member is installed between the fixing member of the casing and the housing and releases an impact applied to the solenoid.

The buffering member is installed between the housing and the second elastic member for thereby decreasing an impact and noise which occurs due to a friction between the housing and the second elastic member.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating a massage chair using a solenoid according to an embodiment of the present invention;

FIG. 2 is a perspective view illustrating a solenoid installed in a backrest of a massage chair of FIG. 1;

FIG. 3 is a back perspective view illustrating a backrest in which a solenoid of FIG. 1 is installed;

FIG. 4 is a disassembled perspective view illustrating a fixing member which fixes a solenoid of FIGS. 2 and 3;

FIG. 5 is a cross sectional view illustrating a state that a solenoid and support plate of FIG. 4 are engaged;

FIG. 6 is a disassembled perspective view illustrating a seat moving device and a backrest rotation device of a massage chair according to the present invention;

FIG. 7 is an enlarged plan view illustrating a moving device and rotation device of FIG. 6;

FIG. 8 is a cross sectional view illustrating a solenoid installed in a massage chair according to another embodiment of the present invention;

FIG. 9 is a disassembled perspective view illustrating a solenoid of FIG. 8; and

FIG. 10 is a view illustrating an installation state of a solenoid according to another embodiment of the present invention.

### DETAILED DESCRIPTION OF THE PREFERRED EMBODIMENTS

The massage chair using a solenoid according to the present invention will be described with reference to the accompanying drawings.

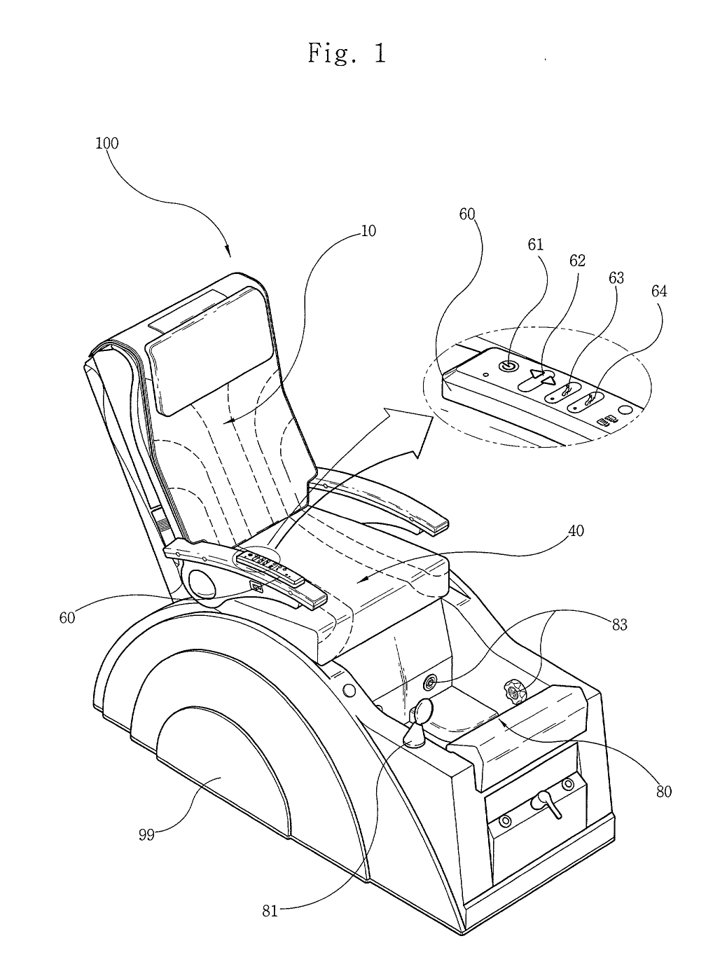

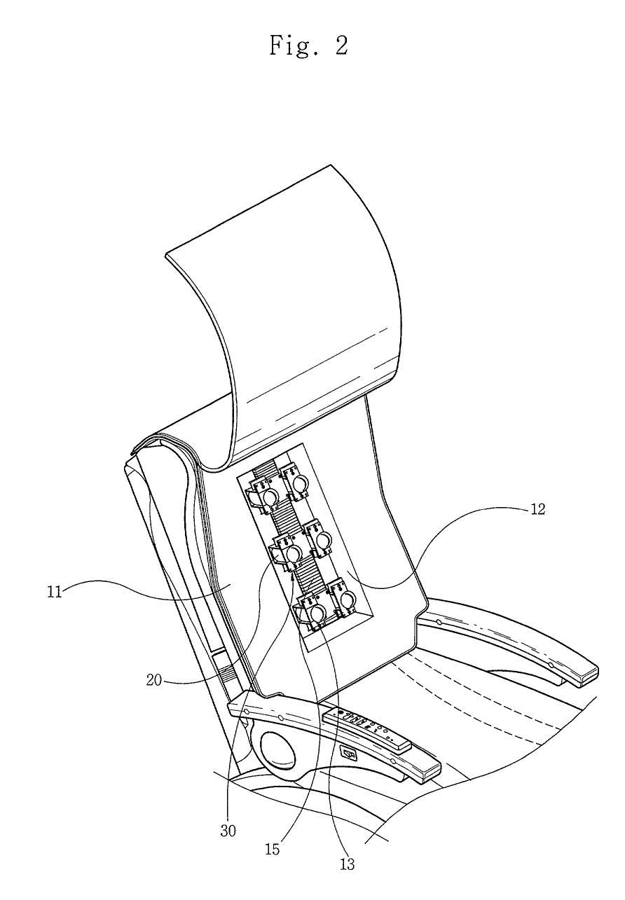

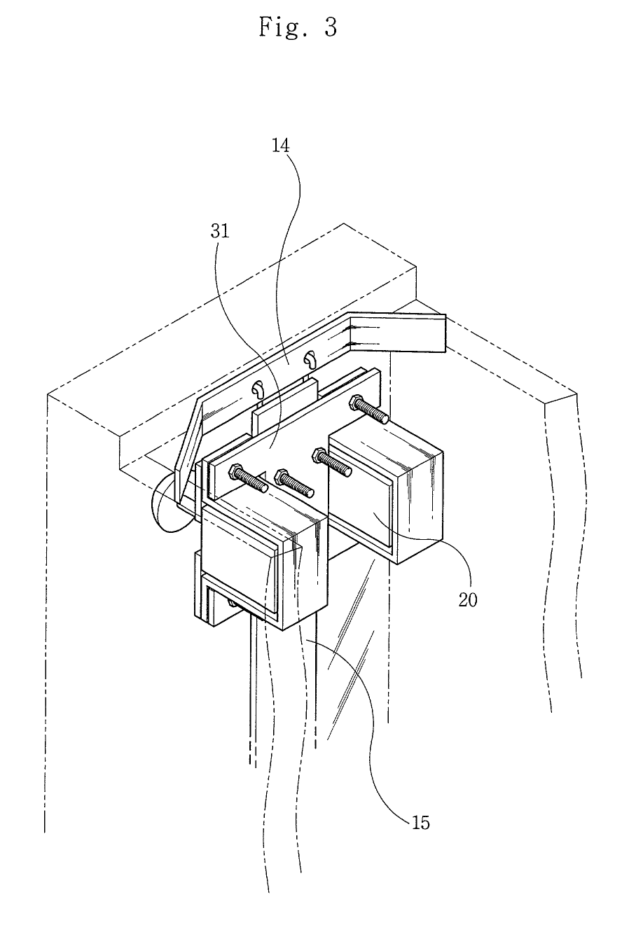

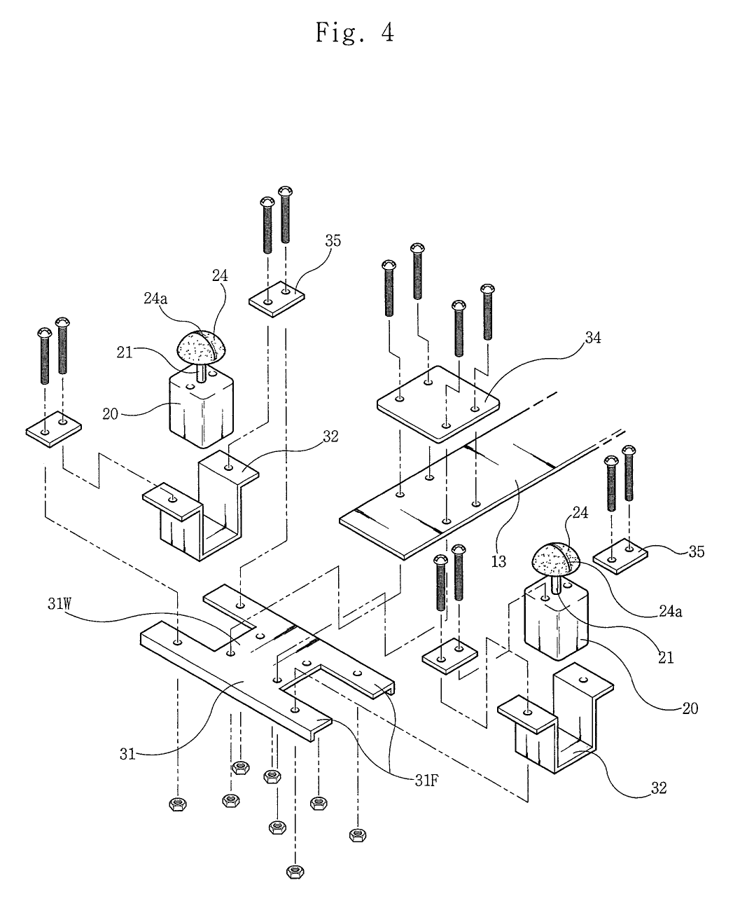

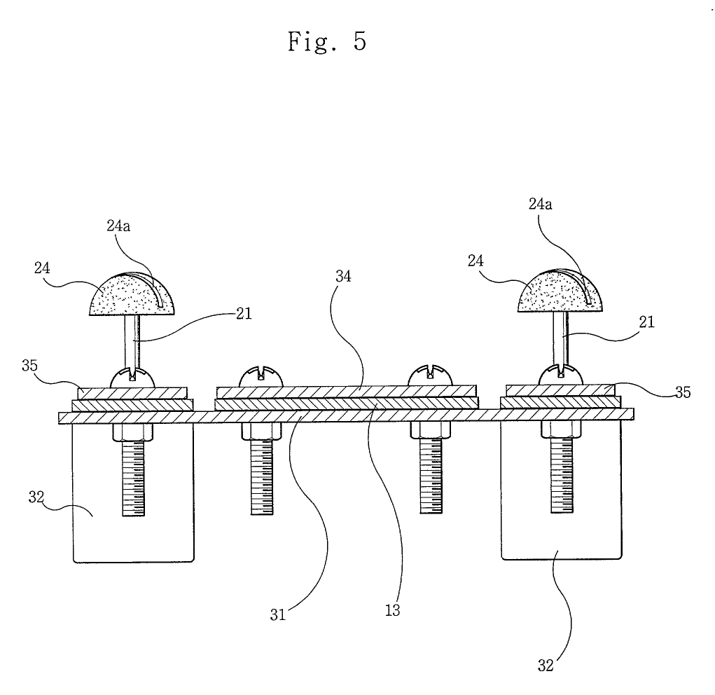

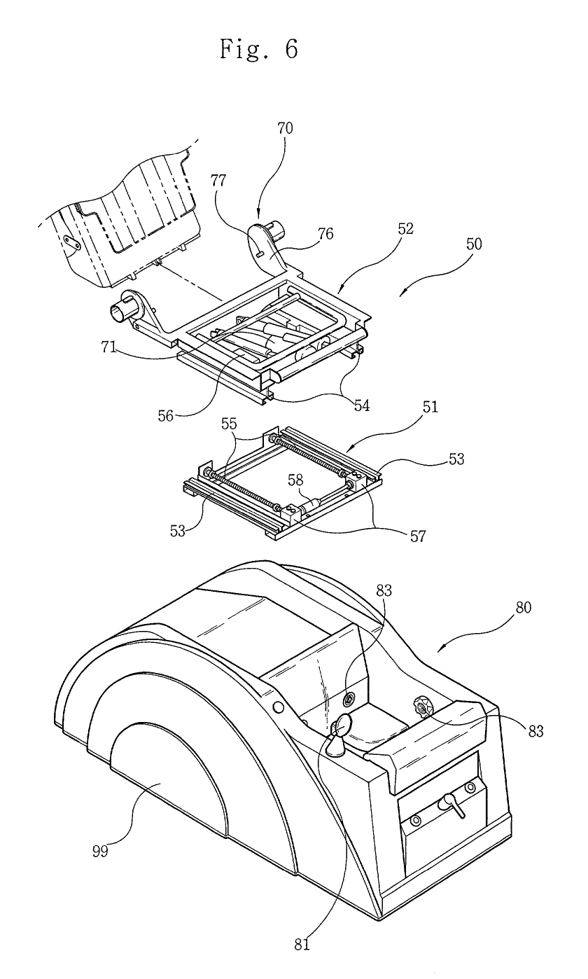

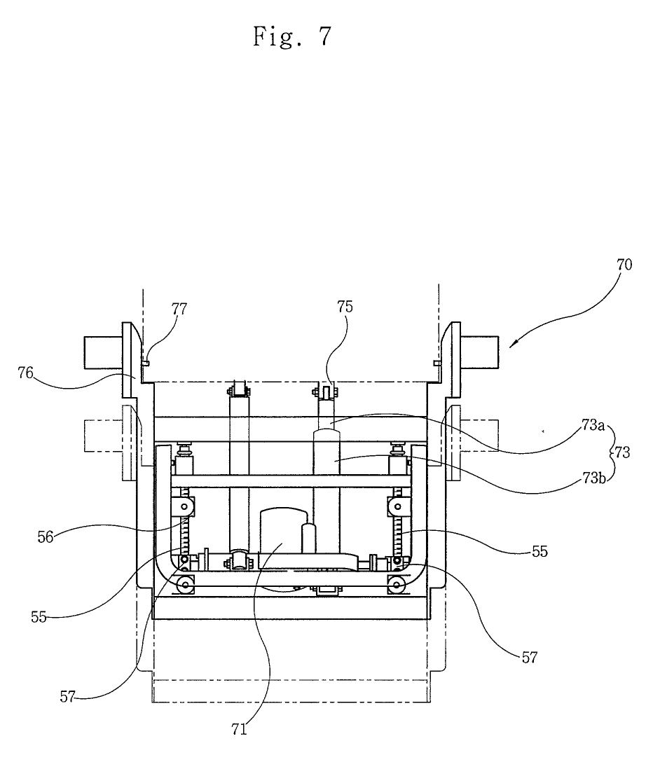

FIG. 1 is a perspective view illustrating a massage chair using a solenoid according to an embodiment of the present invention, FIGS. 2 and 3 are views illustrating a state that a solenoid is installed in a backrest of FIG. 1, FIGS. 4 and 5 are views illustrating an engaged state of a solenoid installed in a backrest, and FIGS. 6 and 7 are views illustrating a seat moving device and a backrest rotation device of a massage chair.

As shown in FIG. 1, a massage chair 100 includes a backrest 10 which supports a user's back, a seat unit 40 which supports a user's hip, a support member 99 which is installed in order for the seat unit 40 to be positioned at a certain height from a bottom, and a foot bath tub 80 which forms a whirlpool using water discharged from a spray unity 81 and a discharging unit 83 for thereby massaging user's feet.

As shown in FIGS. 2 and 3, a plurality of solenoids 20 are connected in the backrest 10 in parallel, and a cushion portion 11 which supports a user's back is formed in the entire portions of the backrest 10. A rectangular receiving groove 12 is formed in a center portion of the cushion portion 11 in a longitudinal direction. A fixing plate 13 is installed in an upper and lower portion of the receiving groove 12. Both ends of the fixing plate 13 are fixed to a support frame 14 which supports the backrest 10.

The fixing plate 13 which is installed in upper and lower sides of the receiving groove 12 is connected by a ring-shaped fixing belt 15. The fixing belt 15 is tensely fixed in such a manner that the fixing plate 13 positioned in the upper portion and the fixing plate 13 positioned in the lower portion are inwardly received.

As shown in FIGS. 4 and 5, the solenoid 20 is positioned at both sides of the fixing belt 15 installed in a longitudinal direction of the backrest 10 and is fixed to the fixing belt 15. There are provided a H-shaped support plate 31 as a fixing member 30 for fixing the solenoid 20 to the fixing belt 15, a first fixing plate 34 which fixes the support plate 31 and the fixing belt 15, a bracket 32 which fixes the support plate 31 and the solenoid 20, and a second fixing plate 35 which fixes the bracket 31 to the support plate 31 and the solenoid 20 and the bracket 32.

The support plate 31 is installed in such a manner that the support plate 31 contacts with a lower surface of the fixing plate 15, and a web 31W which connects a parallel flange 31F of the support plate 31 in a perpendicular direction contacts in a longitudinal direction of the fixing belt 15, and the first fixing plate 34 is installed in an upper surface of the fixing belt 15.

The first fixing plate 34, the fixing belt 15 and the support plate 31 are fixedly engaged using bolts and nuts, and the bolts sequentially pass through the first fixing plate 34, the fixing belt 15 and the web 31W of the support plate 31, and the nuts are coupled to the end portions of the bolts.

The parallel flange 31F of the support plate 31 fixed to the fixing belt 15 is protruded from the left and right sides of the fixing belt 15, and the solenoid 20 is installed between two opposite flanges 31F.

The bracket 32 is formed in such a manner that both ends of the same are bent in an opposite direction in a state that the bracket 32 is bent in a channel shape. The solenoid 20 is installed in the inner portion of the bracket 32, and the portion bent in an opposite direction of the bracket 32 contacts with the upper surface of the parallel flange 31F of the support plate 31.

In a state that the second fixing plate 35 is mounted on an upper surface of the solenoid 20 and an upper surface of the bent portion of the bracket 32, one bolt passes through the second fixing plate 35 and is fixed to the solenoid 20, and the other bolt passes through the second fixing plate 35, the bent portions of the bracket 32 and the flange 31F of the support plate 31 are engaged by the nut.

In an embodiment of the present invention, in the massage chair 100, three pairs of the solenoids 20 are fixed to the fixing belt 15 in an upward direction. A coil, magnet and spring are installed in the interior of the solenoid 20. The magnet is moved by a magnetic force formed by the coil when a power is supplied thereto and reciprocates by an elastic recovering force of the spring which is applied in the opposite direction. At this time, since the above sequential and random operation is performed by the solenoid and a program set in a controller (not shown) by a conventional method, the construction and operation of the same will be omitted.

A rod 21 in which a cushion member 24 is fixed to its front end is connected to the magnet of the solenoid 20 and is extended to an outside of the solenoid 20. The driving direction of the rod 21 is a front direction of the backrest 10, namely, in the direction toward the user sitting in the backrest 10.

The cushion member 24 is formed in a conical shape having a certain radius, and a slit 24a is formed in a radius direction.

A moving device 50 is installed in the seat unit 24 for moving the seat unit 24 forwardly and backwardly. The rotating device 70 is installed between the seat unit 40 and the backrest 10 for adjusting a tilting angle of the backrest 10.

As shown in FIG. 6, the moving device 50 includes a rectangular upper frame 52 which supports a lower portion of the seat unit 40, a lower frame 51 which slidably supports the upper frame 52 in such a manner that a rail 53 which is formed in the front and rear directions at both sides is engaged to a rail groove 54 formed in left and right sides of the upper frame 52, a pair of leads 55 which are arranged in front and rear directions in the inner side of the rail 53 of the lower frame 51, a moving plate 56 which is installed in the upper frame 52 for forwardly and backwardly moving the upper frame 52 with respect to the lower frame 51 in an engaged state with the leads 55 when the leads 55 are rotated, and a transfer motor 58 which is installed in the lower frame 51 and rotates the lead. 55 connected by a gear box 57 in a normal or reverse direction when the power is supplied thereto.

In the moving device 50, when power is supplied to the transfer motor 58, the transfer motor 58 rotates the left and right side leads 55 in a normal and reverse directions, so that the moving plate 56 is forwardly and backwardly moved along the leads 55, and the upper frame 52 is forwardly and backwardly moved, for thereby forwardly and backwardly moving the seat unit 40 installed in the upper frame 52.

As shown in FIGS. 6 and 7, the rotation device 70 includes a rotation motor assembly 71 which is installed in the upper frame 52, and an extendable rod 73 which is formed of a thread-engaged moving rod 73a and rotation rod 73b. A front end of the rotation rod 73a is connected in such a manner that the front end of the same receives a driving force from the motor assembly 71, and the moving rod 73a is rotatably fixed to a fixing rob 75 formed in a lower portion of the backrest 10.

In the rotation device 70, as a power is supplied, the motor assembly 71 is driven, and the rotation rod 73b is rotated in a normal or reverse direction, so that the moving rod 73a screw-engaged to the rotation rod 73b is moved forwardly and backwardly, and the backrest 10 engaged to a hinge protrusion 77 in an inner surface of the bracket 76 of the end portion of both sides of the upper frame 52 is rotated in a forward and backward direction with respect to a central axis for thereby adjusting a tilting angle of the backrest 10.

As shown in FIGS. 1 and 6, the foot bath tub 80 is formed in a support 99 of the seat unit 40 and has a certain depth for thereby storing water at a certain level, and discharging portions 83 and spraying unit 81 are installed in the bottom, side wall and rear wall for spraying water in the direction of the center of the foot bath tub 80 using water pump (not shown) installed in the support 99.

The solenoid 20 installed in the backrest 10, the transfer motor 58 of the moving device 50, and the rotation motor assembly 71 for adjusting a tilting angle of the backrest 10 and the pump of the foot bath tub 80 are controlled by an operation of a corresponding button of the controller 60. A variable capacitor which adjusts the degree of the vibration of the solenoid 20 is installed for thereby adjusting an intensity of the vibration of the solenoid 20.

The operation of the massage chair using a solenoid according to an embodiment of the present invention will be described with reference to the accompanying drawings.

First, a user sits on the massage chair 100. The user adjusts various driving operations of the massage chair 100 using various buttons installed in the controller 60. The controller 80 is capable of controlling the operation of the solenoid 20, a vibration intensity of the solenoid 20, the position of the seat unit 40 based on a driving operation of the transfer motor 58, a tilting angle of the backrest 10 and seat unit 40 based on a driving operation of the motor assembly 71 and a water supply into the interior of the foot bath tub 80 based on a driving operation of the water pump. In addition, the controller 80 controls the massage chair so that a user has a comfortable posture.

The user operates the power switch 61 of the controller 60. When the solenoid 20 is operated, the rod 21 of the solenoid 20 reciprocates between the inside and outside of the solenoid 20 by a magnetic force formed by the coil, so that the cushion member 24 fixed to an end portion pressurizes the user's back.

At this time, since the fixing belt 15 is fixed in a tensed state with respect to the upper and lower side fixing plate 13, a repulsive force with respect to a pressure generated when the solenoid 20 vibrates is absorbed to the fixing belt 15 for thereby enhancing a durability of the solenoid 20. In the case that the solenoid 20 is vibrated in a state that the solenoid 20 is fixed to the fixing member, a repulsive force is directly transferred to the solenoid, so that the repulsive force is not absorbed. Therefore, a defect may occur in the solenoid.

In the case that a pressure based on a vibration of the solenoid 20 is small or large, the variable capacitor (not shown) is adjusted by operating the vibration intensity switch 62 installed in the controller 60. The variable capacitor is capable of adjusting an intensity of the pressure by adjusting the output of the solenoid 20.

The transfer motor 58 is rotated by a user in a normal or reverse direction by operating the switch 63 which controls the transfer motor 58 of the controller 60. At this time, the driving force of the transfer motor 58 rotates the lead 55 through the gear box 57, and the moving plate 56 engaged to the lead 55 is moved along the lead 55 based on the rotation of the lead 55. As the moving plate 56 is moved, the upper frame 52 to which the moving plate 56 is fixed is moved, so that the seat unit 40 is forwardly and backwardly moved based on a user's selection.

As the user operates the switch 64 which controls the motor assembly 71 of the controller 60, the motor assembly 71 is driven, and the rotation rod 73b connected to the motor assembly 71 is rotated. As the rotation rod 73b is rotated, the moving rod 73a is moved, and the extendable rod 73 is extended. At this time, since the rear end of the moving rod 73a is fixed to the fixing rib 75 fixed to the support frame 14 of the backrest 10, the backrest 10 is rotated with respect to the hinge protrusion 77.

As the user operates the water pump, water are sprayed from the spraying portion 83 and spraying unit 81 of the foot bath tub 80 at a high pressure for thereby forming a whirl pool, so that it is possible to massage a user's feet by the whirl pool.

The massage chair using a solenoid according to an embodiment of the present invention is capable of adjusting an intensity of massage when massaging a user using a solenoid and performing a massage of a user's feet.

In addition, since the solenoid is fixed to a fixing belt which maintains a tense state, a repulsive force which occurs during a massage is absorbed by the fixing belt, so that a repulsive force applied to the solenoid is offset for thereby enhancing a durability of the solenoid.

Furthermore, in the present invention, it is possible to adjust a position of a chair based on a user's body style and size.

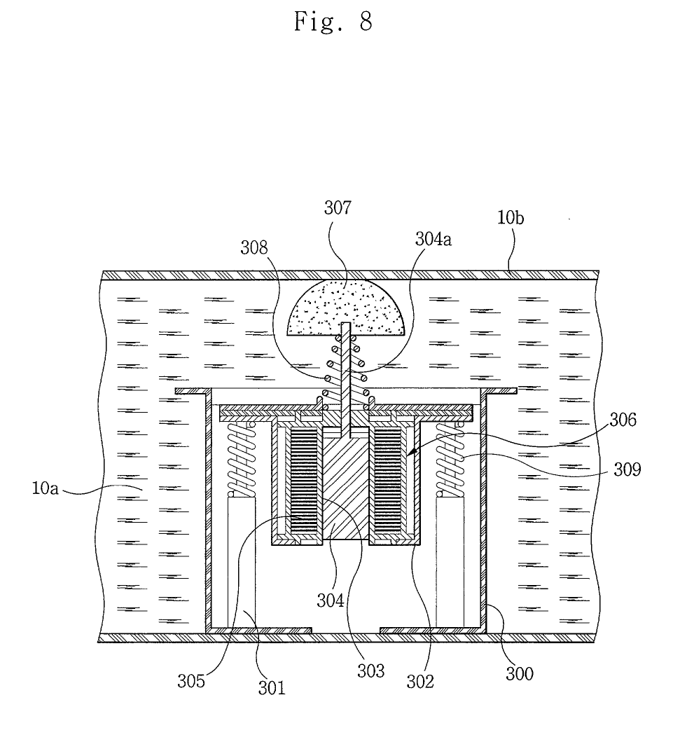

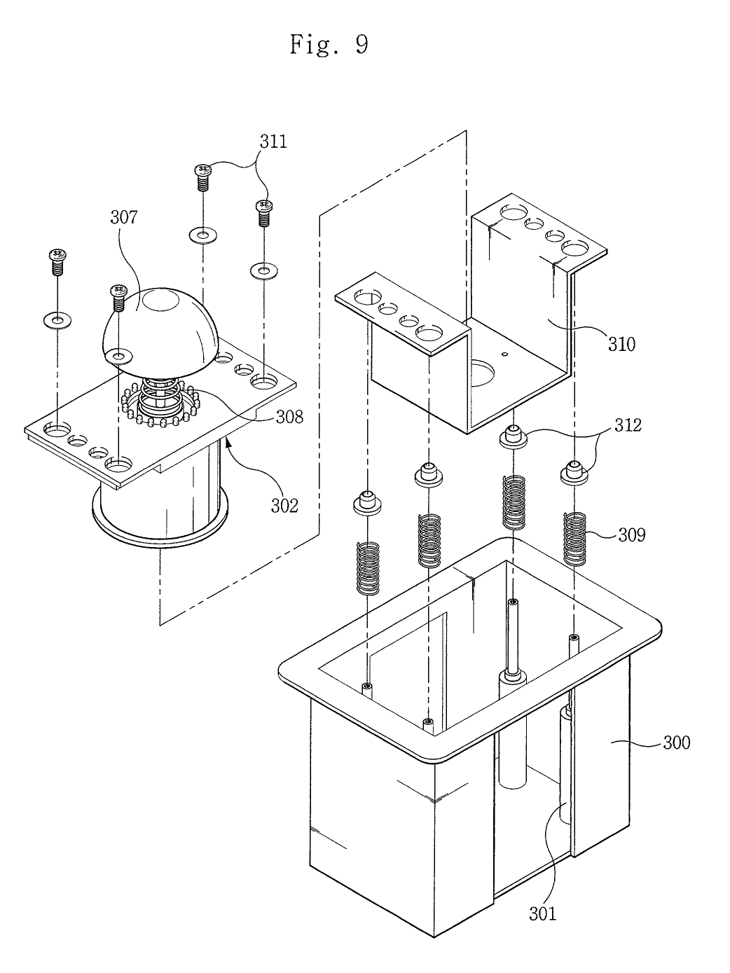

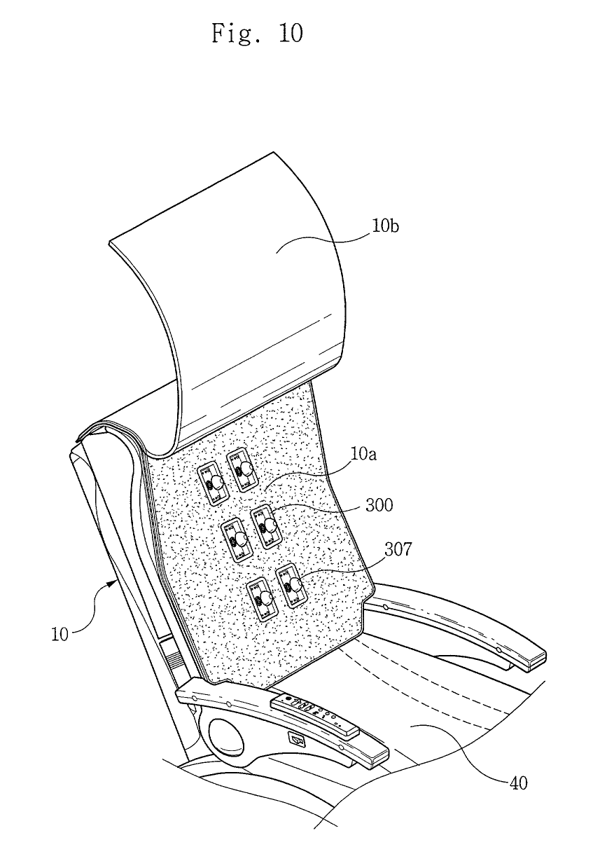

FIGS. 8 and 9 are views illustrating a solenoid installed in a massage chair according to another embodiment of the present invention, and FIG. 10 is a view illustrating an installation state of a solenoid according to another embodiment of the present invention.

The massage chair using a solenoid according to another embodiment of the present invention which includes the foot bath tub capable of spraying water to a user's feet at a high pressure, a seat unit on which a user sits, the rotation device capable of adjusting the tilting angle of the backrest in the forward and backward directions, and the moving device capable of moving the seat unit forwardly and backwardly for thereby forming a whirl pool is the same as the first embodiment of the present invention in their construction and operation, the construction and operation of the same will be omitted. Since the constructions of six solenoids are same, only one solenoid will be described.

There are provided a casing 300 which includes an opened upper side and is embedded in an inner layer 10a in an upward and downward direction, a plurality of solenoids 306 which are installed in a housing 302 engaged to a plurality of fixing members 301 of the casing 300, with a rod 304 engaged to a through hole 303 formed in a center portion reciprocating by a magnetic force which occurs when a power is supplied to a coil 305, a cushion member 307 which is fixed to an end portion of a protrusion shaft 304a extended from the rod 304, a first elastic member 308 which is installed between the upper surface of the solenoid 306 and a cushion member 307 and elastically recovers when the rod 304 vibrates, and a second elastic member 309 which is installed between the fixing member 301 and the housing 302 of the casing 300 for absorbing an impact applied to the solenoid 306.

In the drawings, reference numeral 10b represents an outer layer which covers the inner layer 10a, 310 represents a bracket capable of receiving the housing 302 therein and fixing to the fixing member 301 of the casing 300, 311 represents an engaging member capable of fixing the housing 302 to an end portion of the fixing member 301, and 312 represents a buffering member capable of buffering an impact and noise based on a friction of the bracket 310 and the second elastic member 309.

The operation of the massage chair using a solenoid according to another embodiment of the present invention will be described with reference to the accompanying drawings.

As a power is supplied to a plurality of the solenoids 306 installed in the inner layer 10a of the backrest 10 in parallel through the controller, a magnetic force occurs in the coil 305 of the solenoids 306, and the rod 304 reciprocates in the direction of the backrest 10 by the magnetic force.

Therefore, the cushion member 307 fixed to an end portion of the rod 304 continuously vibrates sequentially or randomly in the direction of the outer layer 10b of the backrest 10 based on a program set in the controller, so that the back of the user who sits on the seat unit 40 is massaged in such a manner that the user's back is pressurized.

The massage chair using a solenoid according to the present invention is capable of decreasing the number of elements used for fixing the solenoids which massage the user's back by supplying the power to the coils for thereby significantly decreasing the fabrication and installation costs. Therefore, the massage chair using a solenoid according to the present invention has a very strong price competitiveness.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a massage chair which includes a foot bath tub capable of spraying water to a user's feet at a high pressure, a seat unit on which a user sits, a rotation device capable of adjusting a tilting angle in a front and rear direction of a backrest, and a moving device capable of forwardly and backwardly moving the seat unit, a massage chair using a solenoid, comprising:
a fixing belt which is embedded in a receiving groove formed in the interior of the backrest in a longitudinal direction;
a plurality of solenoids which are installed in the fixing belt in a longitudinal direction of the backrest by at least one line and pressurize a user's back who sits on the seat unit as a rod reciprocates by a magnetic force occurring when a power is supplied to a coil; and
a fixing means for fixing the solenoid to the fixing belt.

2. The chair of claim 1, wherein a cushion member is fixed to an end portion of the rod of the solenoid.

3. The chair of claim 1, wherein a slit is formed in an upper surface of the cushion member is a radius direction.

4. The chair of either claim 1 or claim 2, wherein said solenoid is fixed to left and right sides of the fixing belt, respectively, and is arranged in a longitudinal direction of the backrest.

5. The chair of either claim 1 or claim 2, wherein said fixing means includes:
a support plate which is fixed to a lower surface of the fixing belt and is extended in a direction of both sides of the fixing belt;
a bracket which covers both side surfaces and lower surface of the solenoid and includes an upper end which is outwardly bent and is mounted on the support plate; and
a fixing plate which is fixed in an upper end of the bracket, wherein an end portion of the fixing plate is fixed by a bolt which passes through the bracket and the support plate, and the other end of the same is fixed to the solenoid by another bolt.

6. The chair of claim 1, wherein said fixing belt is fixed tensely in a ring shape and receives a fixing plate fixed to an upper and lower surface of the support frame which is formed along an inner outer circumferential surface of the backrest.

7. In a massage chair which includes a foot bath tub capable of spraying water to a user's feet at a high pressure, a seat unit on which a user sits, a rotation device capable of adjusting a tilting angle in a front and rear direction of a backrest, and a moving device capable of forwardly and backwardly moving the seat unit, a massage chair using a solenoid, comprising:
a plurality of casings which are embedded in an inner layer of the backrest in an upward and downward direction and includes an opened upper portion;
a plurality of solenoids which are installed in a housing engaged to a fixing member of the casing, with a rod engaged to a through hole formed in a center portion reciprocating by a magnetic force which occurs when a power is supplied to a coil, and are connected in parallel;
a cushion member which is fixed to an end portion of a protrusion shaft extended from the rod; and
a first elastic member which is installed between an upper surface of the solenoid and the cushion member and elastically recovers during a vibration of the rod.

8. The chair of claim 7, wherein a second elastic member is installed between the fixing member of the casing and the housing and releases an impact applied to the solenoid.

9. The chair of either claim 7 or claim 8, wherein a buffering member is installed between the housing and the second elastic member for thereby decreasing an impact and noise which occurs due to a friction between the housing and the second elastic member.
